(19) United States
(12) Patent Application Publication
(10) Pub. No.: US 2010/0102261 A1
(43) Pub. Date: Apr. 29, 2010

(54) Microfluidic valve mechanism

(75) Inventor: Bob Yuan, Belmont, CA (US)

Correspondence Address: HAVERSTOCK & OWENS LLP, 162 N WOLFE ROAD, SUNNYVALE, CA, 94086, US

(73) Assignee: MicroFluidic Systems, Inc.

(21) Appl. No.: 12/290,345

(22) Filed: Oct. 28, 2008

(51) Int. Cl. F16K 31/02; F16K 11/00

(52) U.S. Cl. 251/129.22; 137/596

(57) ABSTRACT

A valve mechanism includes a rigid body structure through which various channel structures are configured. A valve actuation mechanism is coupled to the rigid body structure. The valve mechanism is actuated to move a plunger within a fluid pathway, thereby opening the fluid pathway through the valve mechanism. An actuation element is actuated by the valve actuation mechanism and either directly or indirectly releases a retaining force holding the plunger in closed position. The pressure from the input fluid flow is sufficient to move the plunger once the retaining force is removed, thereby opening the valve mechanism. The valve mechanism can be configured as a single-use device, where the valve mechanism is initially closed and when actuated, is open. Once open, the valve mechanism remains open, even when the valve actuation mechanism is disengaged.

### FIELD OF THE INVENTION

The invention relates to a valve. More particularly, the invention relates to a fluid valve mechanism applied to microfluidic pathways.

### BACKGROUND OF THE INVENTION

A valve is a device that regulates the flow of materials, such as gases, fluids, slurries, or liquids, by opening, closing, or partially obstructing various passageways. The valve includes a valve body and passages that allow flow into and out of the valve, typically referred to as ports. Ports are obstructed or opened by a valve member or disc to control the fluid flow. Valves with two or three ports are the most common, while valves with multiple ports are used in special applications. Nearly all valves are built with some means of external connection at the ports.

The valve body remains stationary within the fluid system, while the valve member is movable so as to control flow. A round type of disc with fluid pathway(s) inside that can be rotated to direct flow between certain ports is typically referred to as a ball. Ball valves are valves which use spherical rotors, except for the interior fluid passageways. Plug valves use cylindrical or conically tapered rotors called plugs. The plugs in plug valves have one or more hollow passageways going sideways through the plug, so that fluid can flow through the plug when the valve is open.

Two-port valves are commonly called two-way valves. Operating positions for such valves can be either closed so that no flow at all goes through, fully open for maximum flow, or sometimes partially open to any degree between fully open and closed. Three-way valves have three ports. Three-way valves are commonly made such that flow coming in at one port is directed to either the second port in one position, the third port in another position, or in an intermediate position so all flow is stopped. Three-way valves are often ball or rotor valves. Many faucets are three-way valves so that incoming cold and hot water can be regulated in varying degrees to output water at a desired temperature.

Many valves are controlled manually with a handle attached to the valve stem. If the handle is turned a quarter of a full turn (90°) between operating positions, the valve is called a quarter-turn valve. Butterfly valves, ball valves, and plug valves are often quarter-turn valves. Valves can also be controlled by devices called actuators. Various types of actuators include electromechanical actuators such as an electric motor or solenoid, pneumatic actuators that are controlled by air pressure, or hydraulic actuators that are controlled by the pressure of a liquid such as oil or water. Actuators can be used for the purpose of automatic control such as in washing machine cycles, remote control such as the use of a centralized control room, or to simply manual controls. Pneumatic actuators and hydraulic actuators need pressurized air or liquid lines to supply the actuator.

A check valve, also referred to as a clack valve, non-return valve, or one-way valve, is a valve that normally allows fluid (liquid or gas) to flow through in only one direction. Check valves are two-port valves, meaning there are two openings in the body, one for fluid to enter and the other for fluid to leave. There are various types of check valves used in a wide variety of applications. Check valves are turned on and off according to a threshold pressure, which is the minimum upstream pressure at which the valve will turn on. For pressures below the threshold pressure, the check valve turns off.

A diaphragm valve is typically used as a shut-off valve in process systems within the food and beverage, pharmaceutical and biotech industries. Conventional diaphragm valve designs are not well suited for regulating and controlling process flows.

There are many other conventional valves including a choke valve, an expansion valve, a gate valve, a globe valve, a knife valve, a needle valve, a piston valve, and a pinch valve. A choke valve lifts up and down a solid cylinder, which is placed around or inside another cylinder that has holes or slots. The choke valve is used for high pressure drops found in oil and gas wellheads. An expansion valve is used for pressure reduction of fluid. A gate valve is used primarily for on and off control, with low pressure drop. A globe valve is useful for regulating fluid flow. A knife valve is used with slurries or powders to provide on and off control. A needle valve is used for accurate flow control. A piston valve is used for regulating fluids that carry solids in suspension. A pinch valve is used for slurry flow regulation. Each of these valves is configured according to accommodate their specific applications.

### SUMMARY OF THE INVENTION

A valve mechanism is configured to control fluid flow. The valve mechanism includes a rigid body structure through which various channel structures are configured. The channel structures include one or more inlet channels, one or more outlet channels, a plunger channel that couples the one or more inlet channels to the one or more output channels, and an actuation channel. A plunger is positioned in the plunger channel, movable between a first plunger position and a second plunger position. The input fluid flow is sufficient to move the plunger from the first plunger position to the second plunger position in the absence of any additional plunger retention force. In the first plunger position, the plunger blocks the fluid pathway between the one or more inlet channels to the one or more outlet channels. In the second plunger position, the fluid pathway is opened. An actuation element is positioned in the actuation channel. The actuation element moves between a first actuated position and a second actuated position. In the first actuated position, the actuation element, either directly or indirectly, applies a retention force to the plunger to retain the plunger in the first plunger position, thereby maintaining the valve mechanism in a closed position. In the second actuated position, the retention force applied to the plunger is removed, thereby enabling the plunger to be moved to the second plunger position, which changes the valve mechanism to an open position. A valve actuation mechanism is coupled to the actuation element to move the actuation element from the first actuation position to the second actuation position.

### BRIEF DESCRIPTION OF THE DRAWINGS

The accompanying drawings, which are incorporated in and form a part of this specification, illustrate embodiments of the invention and, together with the description, serve to explain the principles of the invention but not limit the invention to the disclosed examples.

FIG. 1 illustrates an isometric view of exemplary channel structures of a valve mechanism according to a first embodiment of the present invention.

FIG. 2 illustrates a cut out side view of the channel structures of FIG. 1 along the x-z plane.

FIG. 3 illustrates the cut out side view of FIG. 2 including components added within the channel structures, where the valve mechanism is in a closed position.

FIG. 4 illustrates a cut out side view of the closed valve mechanism along the x-y plane.

FIG. 5 illustrates the cut out side view of the valve mechanism in the open position.

FIG. 6 illustrates a cut out side view of the open valve mechanism along the x-y plane.

FIG. 7 illustrates a cut out side view of a valve mechanism according to a second embodiment of the present invention.

FIG. 8 illustrates the cut out side view of the valve mechanism of FIG. 7 in the open position.

FIG. 9 illustrates a cut out side view of a valve mechanism according to a third embodiment of the present invention.

FIG. 10 illustrates an exploded view of the valve mechanism of FIG. 9.

FIG. 11 illustrates the cut out side view of the valve mechanism of FIG. 9 in the open position.

Embodiments of the valve mechanism are described relative to the several views of the drawings. Where appropriate and only where identical elements are disclosed and shown in more than one drawing, the same reference numeral will be used to represent such identical elements.

### DETAILED DESCRIPTION OF THE PRESENT INVENTION

Reference will now be made in detail to the embodiments of the valve mechanism of the present invention, examples of which are illustrated in the accompanying drawings. While the present invention will be described in conjunction with the embodiments below, it will be understood that they are not intended to limit the invention to these embodiments and examples. On the contrary, the present invention is intended to cover alternatives, modifications and equivalents, which may be included within the spirit and scope of the present invention as defined by the appended claims. Furthermore, in the following detailed description of the present invention, numerous specific details are set forth in order to more fully illustrate the present invention. However, it will be apparent to one of ordinary skill in the prior art that the present invention may be practiced without these specific details. In other instances, well-known methods and procedures, components and processes haven not been described in detail so as not to unnecessarily obscure aspects of the present invention.

Embodiments of the present invention are directed to a valve mechanism for controlling fluid flow through a fluid pathway. The valve mechanism includes a rigid body structure through which various channel structures are configured. A valve actuation mechanism is coupled to the rigid body structure. The valve mechanism is actuated to move a plunger within a fluid pathway, thereby opening the fluid pathway through the valve mechanism. In some embodiments, the valve mechanism is configured as a single-use device, that is the valve mechanism is initially closed and when actuated, is open. Once open, the valve mechanism remains open, even when the valve actuation mechanism is disengaged. In this single-use embodiment, the valve mechanism is not configured to subsequently actuate from the open position back to the closed position, even if the valve actuation mechanism is re-engaged. As the valve mechanism remains open once the valve actuation mechanism is disengaged, the valve mechanism is configured as a power-saving device. The valve actuation mechanism is only powered on during the actuation movement that changes the valve mechanism from closed to open. Once the valve mechanism is open, the valve actuation mechanism is powered down. In some embodiments, the valve mechanism is configured as a two-way valve, which includes a single input channel, a single output channel, and a means for regulating fluid flow between the two channels. In other embodiments, the valve mechanism includes more than two channels, for example multiple input channels and/or multiple output channels, and a means for regulating fluid flow between the channels.

In general, the valve mechanism is configured for use within a fluid pathway, and therefore can be used within an apparatus or system including a fluid pathway. An exemplary application is to include the valve mechanism within an apparatus configured to process a fluid sample, such as a sample preparation apparatus described in the U.S. patent application Ser. No. (MFSI-01800), filed on Oct. 28, 2008, and entitled “A Sample Preparation Apparatus”, which is hereby incorporated in its entirety by reference.

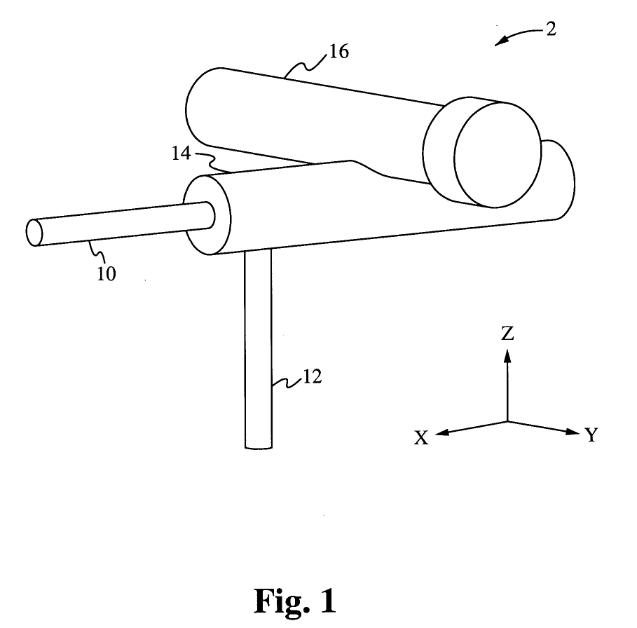

FIG. 1 illustrates an isometric view of exemplary channel structures of a valve mechanism 2 according to a first embodiment of the present invention. FIG. 2 illustrates a cut out side view of the channel structures of FIG. 1 along the x-z plane. The channel structures are formed within the rigid body structure 4 (FIG. 2), which is not shown in FIG. 1 to better illustrate the dimensions and relative positions of the channel structures. The channel structures include an input channel 10, an output channel 12, a plunger channel 14, and an actuation channel 16. As shown in FIG. 1, a longitudinal axis of the plunger channel 14 and a longitudinal axis of the actuation channel 16 are rotated 90 degrees relative to each other. For example, the longitudinal axis of the plunger channel 14 is positioned along an x-axis and the longitudinal axis of the actuation channel 16 is positioned parallel to a y-axis. The plunger channel 14 and the actuation channel 16 are staggered along a z-axis such that portion of the two channels intersect each other to form a common intersecting area 6 (FIG. 2).

The input channel 10 is coupled to an external fluid line (not shown) and receives an input fluid flow. The input channel 10 and the output channel 12 are coupled to the plunger channel 14 to form a fluid pathway through the valve mechanism 2. The output channel 12 is coupled to an external fluid line (not shown) to output fluid flow. The relative positions of each of the channels shown in FIG. 1 is for exemplary purposes, as are the positions of each channel relative to a conventional x, y, z coordinate system. For example, the alignment of the plunger channel 14 and the actuation channel 16 can be skewed from 90 degrees, and/or the actuation channel 16 can be positioned below the plunger channel 14, instead of above the plunger channel 14 as shown in FIG. 1, where the terms “below” and “above” are relative terms only.

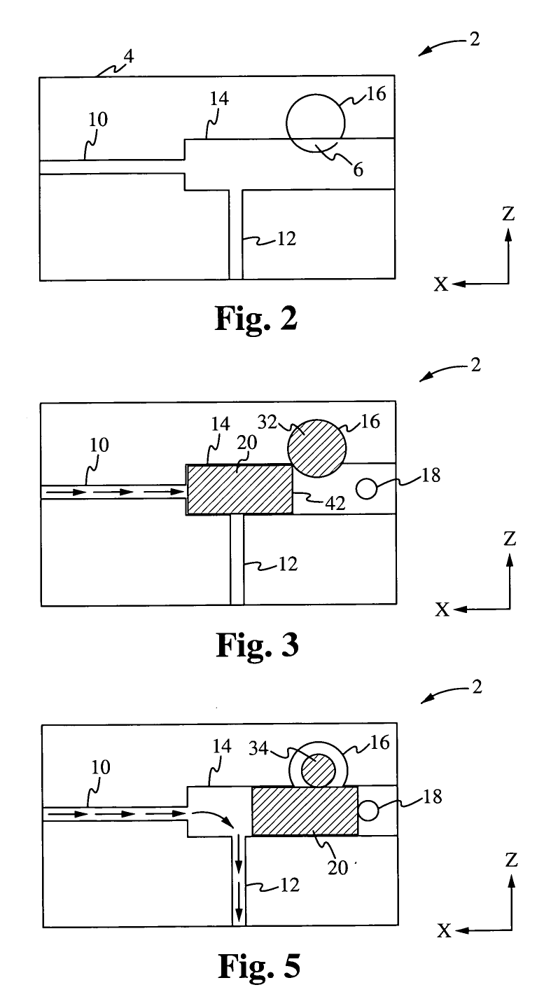

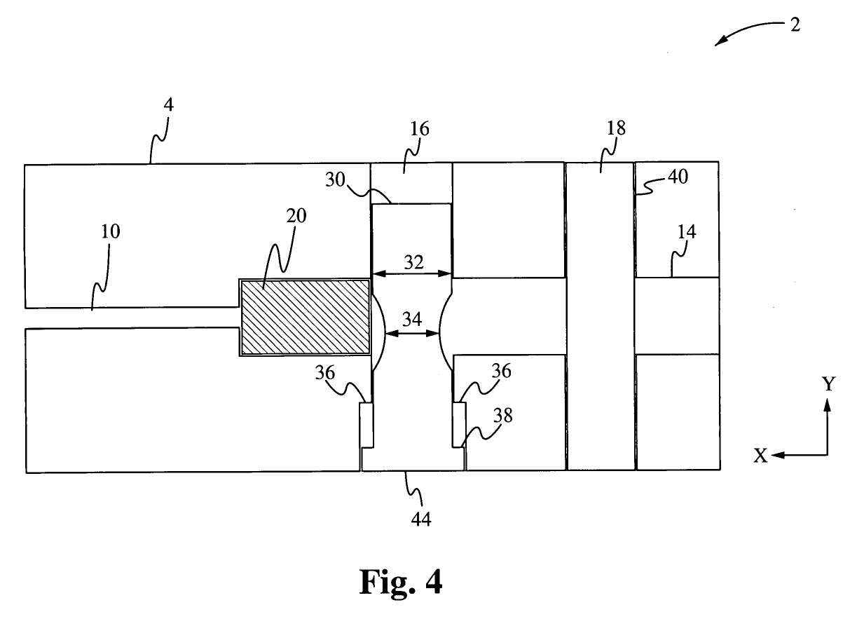

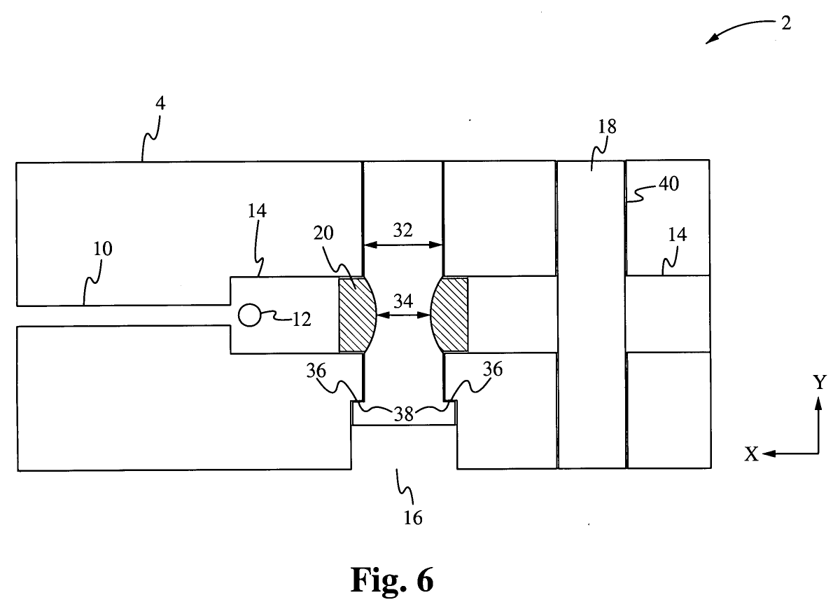

FIG. 3 illustrates the cut out side view of FIG. 2 including components added within the channel structures, where the valve mechanism 2 is in a closed position. FIG. 4 illustrates a cut out side view of the valve mechanism 2 in the closed positioned along the x-y plane. A plunger 20 is positioned in the plunger channel 14. An actuation pin 30 (FIG. 4) is positioned in the actuation channel 16. A plunger stop 18 is positioned in a plunger stop channel 40. The plunger stop channel 40 intersects the plunger channel 14. The plunger 20 is configured to move within the plunger channel 14 along the x-axis. The plunger 20 moves from a first plunger position, as shown in FIGS. 3 and 4, to a second plunger position, as shown in FIGS. 5 and 6. The plunger 20 and the plunger channel 14 are configured such that the plunger 20 moves from the first plunger position to the second plunger position by the force exerted by the input fluid flow entering through the input channel 10. As shown in FIGS. 3 and 4, the plunger 20 is positioned in the first plunger position, also referred to as a start or initial plunger position. In the first plunger position, the plunger 20 prevents fluid flow through plunger channel 14, thereby preventing fluid flow through the valve mechanism 2.

The actuation pin 30 includes a first, wide portion 32 and a second, narrow portion 34. The actuation pin 30 is configured to move within the actuation channel 16 along the y-axis. The actuation pin 30 moves from a first pin position, as shown in FIGS. 3 and 4, to a second pin position, as shown in FIGS. 5 and 6. As shown in FIGS. 3 and 4, the actuation pin 30 is positioned in the first pin position, also referred to as a start or initial pin position. In some embodiments, a diameter of the wide portion 32 is substantially the same as a diameter of the actuation channel 16. As such, when the actuation pin 30 is positioned in the first pin position, at least a portion of the wide portion 32 along the y-axis is aligned with the plunger channel 14, as shown in FIG. 4, and the wide portion 32 of the actuation pin 30 occupies the common area 6, as shown in FIG. 3. In this first pin position, the wide portion 32 of the actuation pin 30 acts as a plunger stop at a back side 42 of the plunger 20. Positioning the wide portion 32 in some or all of the common area 6 along the y-axis prevents the input fluid flow from moving the plunger 20 away from the first plunger position, thereby maintaining the valve mechanism 2 in the closed position.

FIG. 5 illustrates the cut out side view of the valve mechanism 2 in the open position. The cut out side view of FIG. 5 is shown at the longitudinal axis of the plunger channel 14. FIG. 6 illustrates a cut out side view of the valve mechanism 2 of FIG. 5 along the x-y plane. As shown in FIGS. 5 and 6, the actuation pin 30 is positioned in the second pin position and the plunger 20 is positioned in the second plunger position, also referred to as end or actuated positions. The actuation pin 30 is coupled to a valve actuation mechanism (not shown). The valve actuation mechanism is a solenoid or alternative mechanical means for moving the actuation pin 30 from the first pin position to the second pin position. When actuated, the valve actuation mechanism applies force to the actuation pin 30 at a surface 44. The actuation pin 30 is forced into the actuation channel 16, away from the first pin position, until shoulders 38 of the actuation pin 30 are forced against pin stops 36, thereby reaching the second pin position.

When the actuation pin 30 is in the second pin position, the narrow portion 34 does not block the plunger 20 and the input fluid flow against the plunger 20 forces the plunger 20 away from the input channel 10. The plunger 20 is forced away from the input channel 10 until the back side 42 of the plunger 20 is forced against the plunger stopper 18, thereby reaching the second plunger position. In the second plunger position, the plunger 20 enables fluid flow through plunger channel 14 to the output channel 12, thereby enabling fluid flow through the valve mechanism 2. Depending on a shape of the actuation channel 16, the plunger channel 14, and the plunger 20, the plunger 20 occupies some or all of the common area 6 when not in the first plunger position, as in when the plunger 20 is in the second plunger position or when the plunger 20 is moving from the first plunger position to the second plunger position. When the plunger 20 is in the second plunger position, the actuation pin 30 is locked in the second pin position. As such, there is no further need to actuate the valve actuation mechanism, and the valve actuation mechanism is disengaged from the actuation pin 30. As long as there is input fluid flow, the plunger 20 is locked into the second plunger position by the force of the input fluid flow.

The narrow portion 34 of the actuation pin 30 has a smaller diameter than the wide portion 32. In some embodiments, the plunger channel 14, the actuation channel 16, the plunger 20, and the actuation pin 30 are configured as cylinders, and the actuation pin 30 includes a curved transition from the narrow portion 34 to the wide portion 32, where the curved transition matches the cylindrical curve of the plunger 20. In this configuration, while the actuation pin 30 is in the second pin position, the narrow portion 34 of the actuation pin 30 does not occupy the portion of the common area 6 through which the plunger 20 moves. However, the curved transition from the narrow portion 34 to the wide portion 32 does curve into another portion of the common area 6. Since the curved transition matches the shape of the plunger 20, the curved transition does not block the plunger 20 although the curved transition does occupy a portion of the common area 6. Although the narrow portion 34 is shown in FIGS. 4 and 6 as the narrowest portion, in general, reference to the narrow portion refers to the narrowest portion and the curved transition to the wide portion 32. In other embodiments, the narrow portion 34 spans the entire width of the plunger channel 14, and there is no curved transition between the narrow portion 34 and the wide portion 32. In this configuration, no portion of the narrow portion 34 occupies the common area 6 while the actuation pin 30 is in the second pin position. In the first pin position, the wide portion 32 of the actuation pin 30 acts as a plunger stop at a back side 42 of the plunger 20. Positioning the wide portion 32 in some or all of the common area 6 along the y-axis prevents the input fluid flow from moving the plunger 20 away from the first position, thereby maintaining the valve mechanism 2 in the closed position.

Although the plunger channel 14, the actuation channel 16, the plunger 20, and the actuation pin 30 are described above as having cylindrical shapes, and the actuation pin 30 includes a curved transition that matches the cylindrical curve of the plunger 20, other shapes and curved transitions are also contemplated.

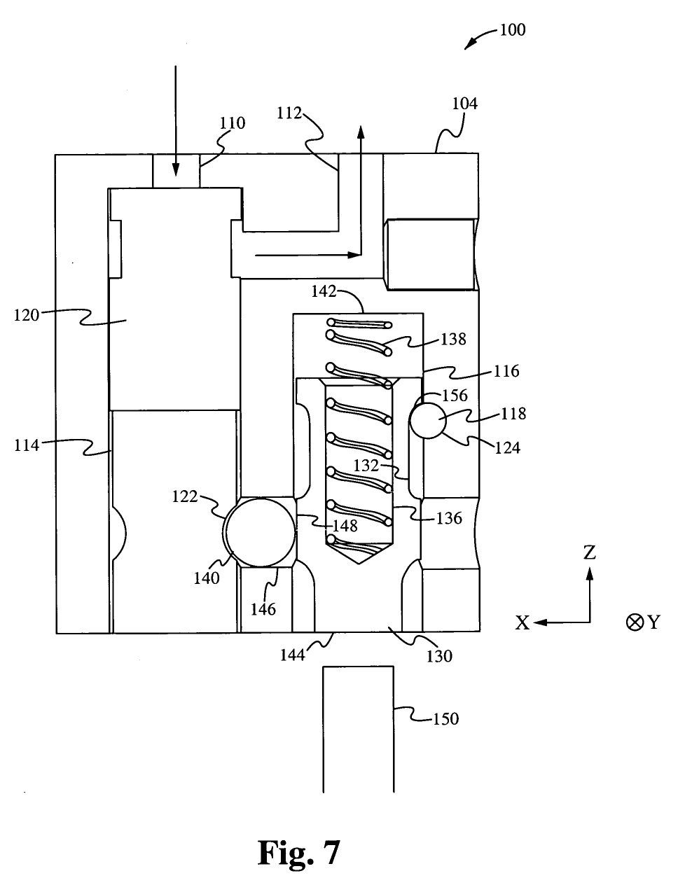

Alternative configurations of a valve mechanism are also contemplated. FIG. 7 illustrates a cut out side view of a valve mechanism 100 according to a second embodiment of the present invention. The valve mechanism 100 is shown in FIG. 7 in a closed position. The valve mechanism 100 includes channel structures formed within a rigid body structure 104. The channel structures include an input channel 110, an output channel 112, a plunger channel 114, an actuation channel 116, a retaining pin channel 124, and an interconnect channel 146.

The input channel 110 is coupled to an external fluid line (not shown) and receives an input fluid flow. The input channel 110 and the output channel 112 are coupled to the plunger channel 114 to form a fluid pathway through the valve mechanism 100. The interconnect channel 146 couples the plunger channel 114 to the actuation channel 116. The output channel 112 is coupled to an external fluid line (not shown) to output fluid flow. The relative positions of the input and output channels shown in FIG. 7 is for exemplary purposes only, as are the positions of each channel relative to a conventional x, y, z coordinate system.

A plunger 120 is positioned in the plunger channel 114. A spring 138 and an actuation pin 130 are positioned in the actuation channel 116. The actuation pin 130 includes a spring opening 136 into which fits a first end of the spring 138. A second end of the spring 138 is coupled to a surface 142 of the actuation channel 116. The spring 138 applies an outward force on the actuation pin 130.

The retaining pin channel 124 extends through the rigid body structure 104 along the y-direction. A retaining pin 118 fits within the retaining pin channel 124. The retaining pin 118 fits within a detent 132 of the actuation pin 130.

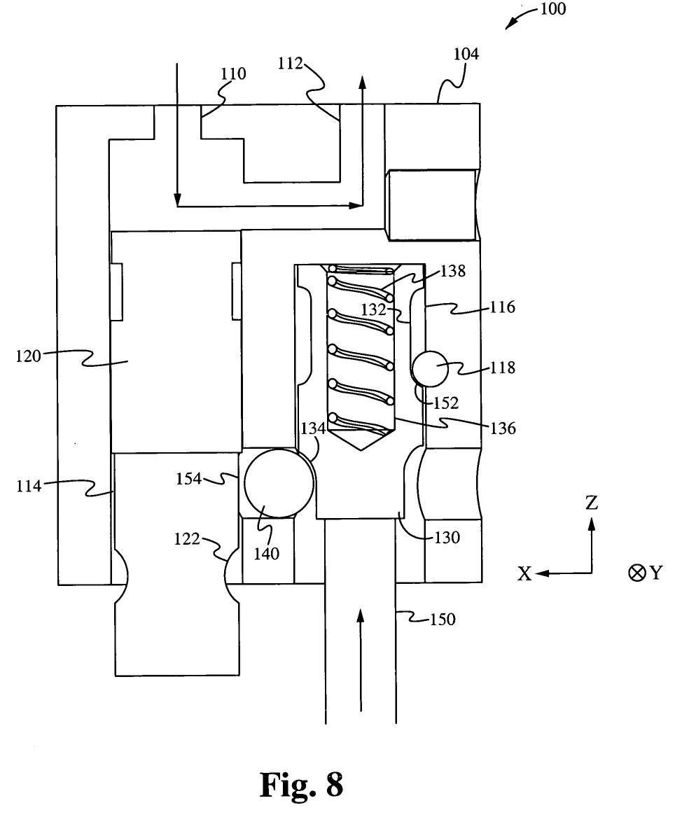

The plunger 120 is configured to move within the plunger channel 114 along the z-axis. The plunger 120 moves from a first plunger position, as shown in FIG. 7, to a second plunger position, as shown in FIG. 8. The plunger 120 and the plunger channel 114 are configured such that the plunger 120 moves from the first plunger position to the second plunger position by the force exerted by the input fluid flow entering through the input channel 110. As shown in FIG. 7, the plunger 120 is positioned in the first plunger position, also referred to as a start or initial plunger position. In the first plunger position, the plunger 120 prevents fluid flow through plunger channel 114, thereby preventing fluid flow through the valve mechanism 100. The plunger 120 is held in the first plunger position by a ball bearing 140 set within detent 122. The ball bearing 140 is positioned in the interconnect channel 146, and is positioned within the detent 122 while the actuation pin 130 is positioned in a first pin position, as shown in FIG. 7.

While in the first pin position, a side surface 148 of the actuation pin 130 prevents the ball bearing 140 from moving out of the detent 122. In general, a float between the ball bearing 140 and the side surface 148 of the actuation pin 130 is less than a depth of the detent 122 in the plunger 120. In this manner, the ball bearing 140 maintains a retaining force on the plunger 120 while the actuation pin 130 is in the first pin position. The dimensions of the ball bearing 140 and the interconnect channel 146 are designed so as not to exceed the maximum amount of float. Without the side surface 148, the ball bearing 140 is forced out of the detent 122 by the pressure exerted on the plunger 120 by the input fluid flow.

The actuation pin 130 is configured to move within the actuation channel 116 along the z-axis. The actuation pin 130 moves from the first pin position, as shown in FIG. 7, to a second pin position, as shown in FIG. 8. As shown in FIG. 7, the actuation pin 130 is positioned in the first pin position, also referred to as a start or initial pin position. The first pin position coincides with the retaining pin 118 forced against a first end 156 of detent 132. The plunger actuation pin 130 is held in the first pin position by the first end 156 of the detent 132 forced against the retaining pin 118. Without the retaining pin 118, the spring 138 forces the actuation pin 130 out of the actuation channel 116.

In the first pin position, the side surface 148 of the actuation pin 130 is aligned with the interconnect channel 146, thereby retaining the ball bearing 140 in the detent 122 and preventing the input fluid flow from moving the plunger 120 away from the first plunger position. As such, maintaining the actuation pin 130 in the first pin position also maintains the valve mechanism 100 in the closed position.

FIG. 8 illustrates the cut out side view of the valve mechanism 100 in the open position. As shown in FIG. 8, the actuation pin 130 is positioned in the second pin position and the plunger 120 is positioned in the second plunger position, also referred to as end or actuated positions. The actuation pin 130 is coupled to a valve actuation mechanism 150. The valve actuation mechanism is a solenoid or alternative mechanical means for moving the actuation pin 130 from the first pin position to the second pin position. When actuated, the valve actuation mechanism 150 applies force to the actuation pin 130 at a surface 144. The actuation pin 130 is forced into the actuation channel 116, away from the first pin position, until the retaining pin 118 is forced against a second end 152 of the detent 132, thereby reaching the second pin position.

When the actuation pin 130 is in the second pin position, a detent 134 in the actuation pin 130 is aligned with the interconnect channel 146. The detent 134 provides sufficient depth for the ball bearing 140 to clear the detent 122 in the plunger 120. The input fluid flow against the plunger 120 forces the plunger 120 away from the input channel 110, thereby providing lateral force on the ball bearing 140. Since the side surface 148 no longer prevents the ball bearing from moving laterally, the ball bearing 140 is forced into the detent 134. With the ball bearing 140 clear of the detent 122, the plunger 120 is forced downward into the second plunger position, as shown in FIG. 8. The second plunger position is determined by a plunger stop (not shown) included in the plunger channel 114 or as part of an external surface or device to which the valve mechanism 100 is coupled. In the second plunger position, the plunger 120 enables fluid flow through plunger channel 114 to the output channel 112, thereby enabling fluid flow through the valve mechanism 100. While in the second plunger position, a side surface 154 of the plunger 120 prevents the ball bearing 140 from moving out of the detent 134. In general, a float between the ball bearing 140 and the side surface 154 of the plunger 120 is less than a depth of the detent 134 in the actuation pin 130. In this manner, the ball bearing 140 maintains a retaining force on the actuation pin 130 while the plunger 120 is in the second plunger position. As such, when the plunger 120 is in the second plunger position, the actuation pin 130 is locked in the second pin position. Accordingly, there is no further need to actuate the valve actuation mechanism 150 once the actuation pin 130 is locked in the second pin position, and the valve actuation mechanism 150 is disengaged from the actuation pin 130. As long as there is input fluid flow, the plunger 120 is locked into the second plunger position by the force of the input fluid flow.

Although the movable retaining element 140 is described above as a ball bearing, it is understood that any conventional element can be used that can be laterally moved in response to the movement of the plunger 120 in the plunger channel 114. For example, the detent 122 can be configured with a ramp profile or cam, and the element 140 can be configured as a sliding rod or pin coupled to the ramp or cam.

As an alternative configuration, the valve mechanism 100 can be reconfigured to replace the actuation pin 130, the ball bearing 140, and interconnect channel 146 with a rotating plunger release barrel that has a cam surface. In a first barrel position, the plunger is latched into the first plunger position by the barrel, thereby preventing movement of the plunger due to the input fluid flow. In this first barrel position, the valve mechanism is closed. When the valve actuation mechanism is forced against the cam surface, the plunger release barrel rotates from the first barrel position to a second barrel position, thereby releasing the plunger so as to be moved by the input fluid flow. The input fluid flow forces the plunger from the first plunger position to the second plunger position. In the second barrel position, the valve mechanism is open.

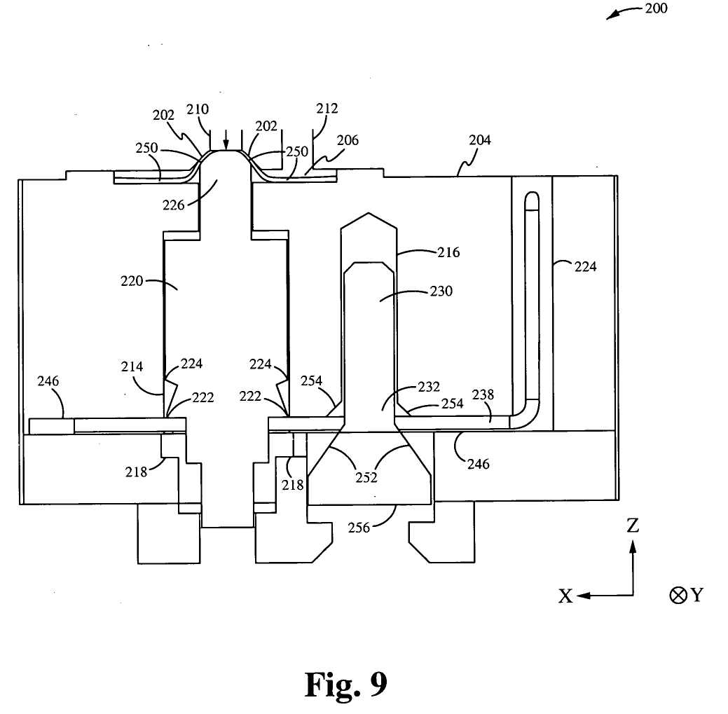

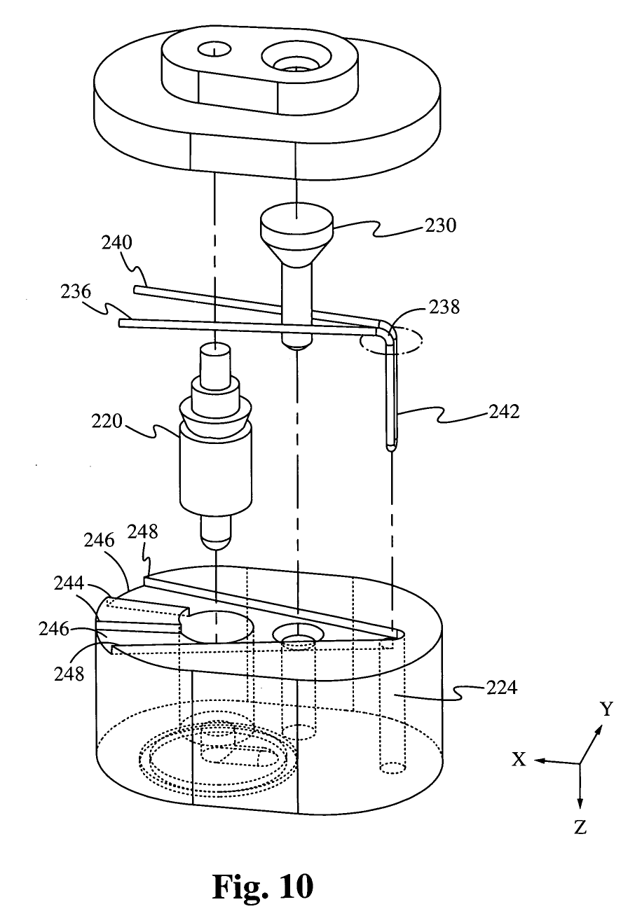

FIG. 9 illustrates a cut out side view of a valve mechanism 200 according to a third embodiment of the present invention. FIG. 10 illustrates an exploded view of the valve mechanism 200. The valve mechanism 200 is shown in FIG. 9 in a closed position. The valve mechanism 200 includes channel structures formed within a rigid body structure 204. The channel structures include an input channel 210, an output channel 212, a plunger channel 214, an actuation channel 216, a valve spring arm channel 246, a valve spring base channel 224, and an interconnect channel 206.

The input channel 210 is coupled to an external fluid line (not shown) and receives an input fluid flow. The input channel 210 and the output channel 212 are coupled to the interconnect channel 206 to form a fluid pathway through the valve mechanism 200. The input channel 210 is coupled to the interconnect channel 206 via a conical surface 202. The plunger channel 214 is coupled to the interconnect channel 206. The valve spring arm channel 246 couples the valve spring base channel 224 to the actuation channel 216 and to the plunger channel 214. The output channel 212 is coupled to an external fluid line (not shown) to output fluid flow. The relative positions of the input and output channels shown in FIG. 9 is for exemplary purposes only, as are the positions of each channel relative to a conventional x, y, z coordinate system.

A spring 238 is configured as a wire spring clip that includes a spring base 242 and two spring arms, a first spring arm 240 and a second spring arm 236. The spring base 242 is positioned in the valve spring base channel 224. The first spring arm 240 and the second spring arm 236 are positioned in the valve spring arm channel 246. As shown in FIG. 10, the valve spring arm channel 246 is configured with closed position stops 244 and open position stops 248. The spring 238 is configured to compress the spring arms 236 and 240 together. In a closed position, the two spring arms 236 and 240 are positioned against the closed spring stops 244. In an open position, the two spring arms 236 and 240 are forced against the open position stops 248. The two spring arms 236 and 240 are forced apart and against the open position stops 248 by movement of an actuation pin 230.

The actuation pin 230 is positioned in the actuation channel 216. The actuation pin 230 includes a narrow portion 232 and a tapered portion 252. The narrow portion 232 has a diameter that is smaller than a distance between the two spring arms 236 and 240 at the actuation channel 216 while the spring 238 is in the closed position. The actuation pin 230 is configured to move within the actuation channel 216 along the z-axis. The actuation pin 30 moves from a first pin position, as shown in FIG. 9, to a second pin position where the tapered portion 252 rests against a stop 254 within the actuation channel 216. As the actuation pin 230 moves from the first pin position to the second pin position, the tapered portion 252 of the actuation pin 230 forces apart the two spring arms 236 and 240. The second pin position coincides with the two spring arms 236 and 240 forced against the open position stops 248.

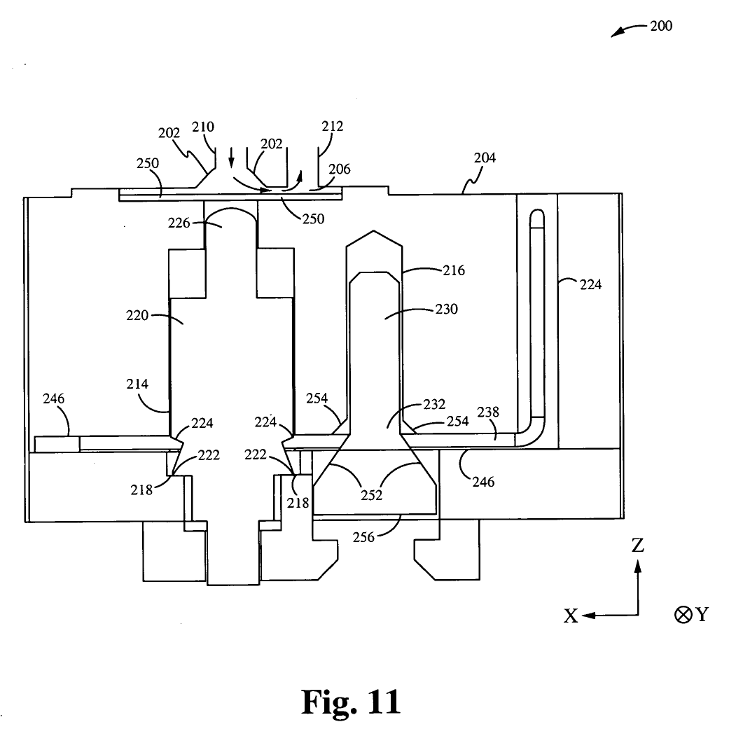

A plunger 220 is positioned in the plunger channel 214 and is configured to move within the plunger channel 214 along the z-axis. The plunger 220 moves from a first plunger position, as shown in FIG. 9, to a second plunger position, as shown in FIG. 11. The first plunger position is also referred to as a start or initial plunger position. In the first plunger position, the plunger 220 prevents fluid flow through interconnect channel 206, thereby preventing fluid flow through the valve mechanism 200. The plunger 220 and the plunger channel 214 are configured such that the plunger 220 moves from the first plunger position to the second plunger position by the force exerted by the input fluid flow entering through the input channel 210. The plunger 220 is held in the first plunger position by the spring arms 236 and 240 positioned in the closed position, that is against the closed position stops 244. In the closed position, the two spring arms 236 and 240 are positioned against plunger extensions 222, thereby preventing the plunger 220 from moving out of the plunger channel 214 (in the negative z-direction).

While in the first plunger position, a ball end 226 of the plunger 220 is pressed against a diaphragm 250, which flexes inward and seats against the conical surface 202, thereby blocking fluid flow from the inlet channel 210 to the outlet channel 212. The diaphragm 250 is fluid-resistant and flexible. In some embodiments, the diaphragm is made of rubber. The diaphragm 250 is coupled to the interconnect channel 206, and provides a fluid barrier between the interconnect channel 206 and the plunger channel 214. The diaphragm 250 effectively separates a wet-side (fluid flow-side) from a dry-side (plunger-side) allowing the valve materials to be isolated and free from bio-compatibility issues that might occur if contacted by the fluid.

FIG. 11 illustrates the cut out side view of the valve mechanism 200 in the open position. As shown in FIG. 11, the plunger 220 is positioned in the second plunger position, also referred to as an end or actuated position. To move the plunger 220 from the first plunger position to the second plunger position, the actuation pin 230 is moved from the first pin position to the second pin position, thereby expanding the two spring arms 236 and 240 to the open position. While in the open position, the distance between the two spring arms 236 and 240 at the plunger channel 214 is greater than the diameter of the plunger 220 at the plunger extensions 222, thereby preventing the two spring arms 236 and 240 from retaining the plunger 220 in the first plunger position. While the two spring arms 236 and 240 are in the open position, the plunger 220 is forced from the first plunger position to the second plunger position by the force of the input fluid flow. The second plunger position coincides with the plunger extensions 222 contacting the stops 218. The actuation pin 230 is then released to return to the first pin position, thereby releasing the two spring arms 236 and 240 to return to the spring closed position. With the plunger 220 in the second plunger position, the two spring arms 236 and 240 are positioned against plunger extensions 224 while in the spring closed position.

The actuation pin 230 is coupled to a valve actuation mechanism 150 (FIG. 8). The valve actuation mechanism is a solenoid or alternative mechanical means for moving the actuation pin 230 from the first pin position to the second pin position. When actuated, the valve actuation mechanism 150 applies force to the actuation pin 230 at a surface 256. The actuation pin 230 is forced into the actuation channel 216, away from the first pin position, until the tapered portion 252 is forced against the stop 254, thereby reaching the second pin position. Retraction of the valve actuation mechanism 150 releases the actuation pin 230. The compression force of the two spring arms 236 and 240 against the tapered portion 252 forces the actuation pin 230 from the second pin position back to the first pin position.

In the second plunger position, the plunger 220 and the diaphragm 250 are retracted from the conical surface 202, which enables fluid flow from the input channel 210, through the interconnect channel 206, to the output channel 212, thereby enabling fluid flow through the valve mechanism 200. When the plunger 220 is in the second plunger position, there is no further need to actuate the valve actuation mechanism 150, and the valve actuation mechanism 150 is disengaged from the actuation pin 230.

Compared with the valve mechanism 100, the valve mechanism 200 uses less force to open the valve and enable fluid flow. The valve release of the valve mechanisms 200 does not need to overcome the plunger-in-cylinder bore friction required to open the flow path, as in the valve mechanism 100. Because the diaphragm 250 is stretched to close the valve in the initial state, the diaphragm itself functions as a release spring to open the flow path when the retaining force is released (moving the actuation pin to the second pin position).

The present invention has been described in terms of specific embodiments incorporating details to facilitate the understanding of the principles of construction and operation of the invention. The specific configurations shown and the methodologies described in relation to the valve mechanism are for exemplary purposes only. Such reference herein to specific embodiments and details thereof is not intended to limit the scope of the claims appended hereto. It will be apparent to those skilled in the art that modifications may be made in the embodiment chosen for illustration without departing from the spirit and scope of the invention.

What is claimed is:

1. A valve mechanism to regulate fluid flow, the valve comprising:
a. a fluid pathway;
b. a movable plunger coupled to the fluid pathway and configured to be moved by a force of fluid flowing through the fluid pathway, wherein the plunger is movable between a first plunger position and a second plunger position such that in the first plunger position the plunger blocks fluid flow through the fluid pathway and the valve mechanism is closed, and in the second plunger position fluid flows through the fluid pathway and the valve mechanism is open; and
c. an actuation pin coupled to the plunger, wherein the actuation pin is movable between a first pin position where the actuation pin prevents movement of the plunger, and a second pin position where the actuation pin does not prevent movement of the plunger and the fluid flow forces the plunger from the first plunger position to the second plunger position.

2. The valve mechanism of claim 1 wherein the valve mechanism is a 2-way valve.

3. The valve mechanism of claim 1 wherein the actuation pin is restricted to actuation in a single direction.

4. The valve mechanism of claim 1 further comprising an actuation mechanism coupled to the actuation pin, wherein the actuation mechanism is configured to move the actuation pin from the first pin position to the second pin position.

5. The valve mechanism of claim 4 wherein the actuation mechanism comprises a solenoid.

6. The valve mechanism of claim 4 wherein the actuation mechanism is de-coupled from the actuation pin after the actuation pin is in the second pin position, further wherein after de-coupling, the actuation pin remains in the second pin position.

7. The valve mechanism of claim 1 wherein the plunger is restricted to actuation in a single direction.

8. A valve mechanism to regulate fluid flow, the valve comprising:
a. an input channel configured to input fluid flow;
b. an output channel configured to output fluid flow;
c. a plunger channel configured to provide fluid flow from the input channel to the output channel;
d. a movable plunger positioned within the plunger channel and configured to be moved by a pressure of the input fluid flow, wherein the plunger is movable between a first plunger position and a second plunger position such that in the first plunger position the plunger blocks fluid flow from the input channel to the output channel, and in the second plunger position fluid flows from the input channel to the output channel;
e. an actuation channel positioned such that a portion of the actuation channel crosses a portion of the plunger channel, thereby forming a common area through which the plunger moves; and
f. an actuation pin positioned within the actuation channel, wherein a first pin portion of the actuation pin has a first pin diameter and a second pin portion of the actuation pin has a second pin diameter that is less than the first pin diameter, further wherein the actuation pin is movable between a first pin position where the first pin portion is coincident with the crossing of the plunger channel and the actuation channel and the first pin portion occupies at least a portion of the common area, and a second pin position where the second pin portion is aligned in a same cross-section of the actuation channel as the common area and the second pin portion does not occupy the common area, wherein when the plunger is in the first plunger position the actuation pin is in the first pin position, thereby preventing movement of the plunger to the second plunger position, and when the actuation pin is moved to the second pin position movement of the plunger to the second plunger position is enabled.

9. The valve mechanism of claim 8 wherein a longitudinal axis of the actuation channel is rotated substantially 90 degrees relative to a longitudinal axis of the intermediate channel.

10. The valve mechanism of claim 8 wherein the valve mechanism is a 2-way valve.

11. The valve mechanism of claim 8 wherein the actuation pin is restricted to actuation in a single direction.

12. The valve mechanism of claim 8 further comprising an actuation mechanism coupled to the actuation pin, wherein the actuation mechanism is configured to move the actuation pin from the first pin position to the second pin position.

13. The valve mechanism of claim 12 wherein the actuation mechanism comprises a solenoid.

14. The valve mechanism of claim 12 wherein the actuation mechanism is de-coupled from the actuation pin after the actuation pin is in the second pin position, further wherein after de-coupling, the actuation pin remains in the second pin position.

15. The valve mechanism of claim 8 wherein the plunger is restricted to actuation in a single direction.

16. The valve mechanism of claim 8 wherein the second pin portion is contoured to match a shape of the plunger.

17. A valve mechanism to regulate fluid flow, the valve comprising:
a. an input channel configured to input fluid flow;
b. an output channel configured to output fluid flow;
c. a plunger channel configured to provide fluid flow from the input channel to the output channel;
d. a movable plunger positioned within the plunger channel and configured to be moved by a pressure of the input fluid flow, wherein the plunger is movable between a first plunger position and a second plunger position such that in the first plunger position the plunger blocks fluid flow from the input channel to the output channel, and in the second plunger position fluid flows from the input channel to the output channel, further wherein the plunger includes a first detent;
e. an actuation channel;
f. an interconnect channel coupled between the plunger channel and the actuation channel, and a movable element positioned within the interconnect channel, wherein when the plunger is in the first plunger position the first detent is aligned with the interconnect channel; and
g. an actuation pin positioned within the actuation channel, wherein the actuation pin includes a second detent, further wherein the actuation pin is movable between a first pin position where a side surface of the actuation pin is aligned with the interconnect channel and a second pin position where the second detent is aligned with the interconnect channel, wherein when the plunger is in the first plunger position the actuation pin is in the first pin position, thereby positioning the movable element in the first detent, which prevents movement of the plunger to the second plunger position, and when the actuation pin is moved to the second pin position the second detent is aligned with the interconnect channel, which forces the movable element out of the first detent and into the second detent, thereby enabling movement of the plunger to the second plunger position.

18. The valve mechanism of claim 17 wherein the movable element is a round object.

19. The valve mechanism of claim 17 further comprising a spring element with a first end coupled to a surface of the actuation channel and a second end coupled to the actuation pin.

20. The valve mechanism of claim 19 further comprising a retaining pin, wherein the actuation pin includes a third detent and the retaining pin is positioned at a first end of the third detent to retain the actuation pin in the first pin position.

21. The valve mechanism of claim 20 wherein the retaining pin is positioned at a second end of the third detent to retain the actuation pin in the second pin position.

22. The valve mechanism of claim 17 wherein the valve mechanism is a 2-way valve.

23. The valve mechanism of claim 17 wherein the actuation pin is restricted to actuation in a single direction.

24. The valve mechanism of claim 17 further comprising an actuation mechanism coupled to the actuation pin, wherein the actuation mechanism is configured to move the actuation pin from the first pin position to the second pin position.

25. The valve mechanism of claim 24 wherein the actuation mechanism comprises a solenoid.

26. The valve mechanism of claim 24 wherein the actuation mechanism is de-coupled from the actuation pin after the actuation pin is in the second pin position, further wherein after de-coupling, the actuation pin remains in the second pin position.

27. The valve mechanism of claim 17 wherein the plunger is restricted to actuation in a single direction.

28. A valve mechanism to regulate fluid flow, the valve comprising:
a. an input channel configured to input fluid flow;
b. an output channel configured to output fluid flow;
c. a plunger channel configured to provide fluid flow from the input channel to the output channel;
d. a movable plunger positioned within the plunger channel and configured to be moved by a pressure of the input fluid flow, wherein the plunger is movable between a first plunger position and a second plunger position such that in the first plunger position the plunger blocks fluid flow from the input channel to the output channel, and in the second plunger position fluid flows from the input channel to the output channel;
e. a rotating barrel assembly coupled to the plunger, wherein the barrel assembly includes a latching mechanism and a cam surface, further wherein the barrel assembly is movable between a first barrel position where the latching mechanism is coupled to the plunger to retain the plunger in the first plunger position, and a second barrel position where the latching mechanism is de-coupled from the plunger, thereby enabling movement of the plunger to the second plunger position; and
f. an actuation mechanism coupled to the cam surface, wherein the actuation mechanism is configured to apply force to the cam surface, thereby rotating the barrel assembly from the first barrel position to the second barrel position.

29. The valve mechanism of claim 28 wherein the valve mechanism is a 2-way valve.

30. The valve mechanism of claim 28 wherein the barrel assembly is restricted to actuation in a single direction.

31. The valve mechanism of claim 28 wherein the actuation mechanism comprises a solenoid.

32. The valve mechanism of claim 28 wherein the actuation mechanism is de-coupled from the actuation pin after the barrel assembly is in the second barrel position, further wherein after de-coupling, the barrel assembly remains in the second barrel position.

33. The valve mechanism of claim 28 wherein the plunger is restricted to actuation in a single direction.
